(19) United States
(12) Patent Application Publication
(10) Pub. No.: US 2008/0044648 A1
(43) Pub. Date: Feb. 21, 2008

(54) HEAT PROTECTED CONSTRUCTION MEMBERS AND METHOD

(76) Inventors: Patricia Billings, Leawood, KS (US); David C. Rada, Lake Quivira, KS (US)

Correspondence Address: BLACKWELL SANDERS LLP, 4801 Main Street, Suite 1000, KANSAS CITY, MO, 64112, US

(21) Appl. No.: 11/465,600

(22) Filed: Aug. 18, 2006

(51) Int. Cl. B32B 15/04; B05D 1/12; B05D 1/36; G11B 11/105; B32B 13/00

(52) U.S. Cl. 428/332; 428/703; 428/457; 427/180; 427/403; 427/402

(57) ABSTRACT

A structural member such as a steel I-beam or column covered with a heat resistant coating for protection against high temperatures. The coating is sprayed onto the structural member after a reinforcing mesh has been applied. The coating is specially formulated to resist extremely high temperatures and includes cement, gypsum, perlite, a liquid catalyst that includes styrene acrylic, and water.

### FIELD OF THE INVENTION

This invention relates generally to construction members such as columns and beams that provide structural support in buildings and more particularly to the protection of structural members against high temperatures.

### BACKGROUND OF THE INVENTION

Many buildings and other relatively large structures make use of steel beams and columns for their primary structural support. Although steel structural members function well for the most part, problems can arise if they are subjected to excessive heat. Steel loses its ability to provide adequate structural support at a temperature of about 1000° F. Consequently, if a building is exposed to heat of that magnitude, the entire building can fail structurally and possibly collapse with catastrophic results. A prime example is the collapse of the towers of the World Trade Center when they were subjected to fires fueled by burning aviation fuel.

While attempts have been made to provide heat insulation on steel structural columns and beams to protect them from high temperatures, only limited success has been achieved. The best heat insulation that is practical for widespread use in building construction can prevent steel structural members from reaching 1000° F. for only about three hours if the surrounding temperature is 2000° F. Consequently, there is a compelling need for greater protection.

### SUMMARY OF THE INVENTION

The present invention is directed to the coating of construction beams and columns with a heat insulating material that is formulated to markedly enhance the ability of the structural members to withstand a high temperature environment without failing.

In particular, it is an object of the invention to provide a coated structural member that can withstand high temperatures without failing for a longer time period than has been achieved in the past.

An additional object of the invention is to provide an improved method of coating structural members to enhance their resistance to high temperatures.

In accordance with the invention, structural members such as steel columns or steel beams are provided with a heat resistant coating that is formulated to protect the structural members from high temperatures. The coating of the present invention includes cement, gypsum, perlite and a liquid catalyst. The coating may be sprayed or otherwise applied to the structural member. Preferably, reinforcement which may take the form of a steel mesh is applied to the structural member before the coating. The reinforcement minimizes cracking of the coating in the event of thermal expansion of the structural member under exposure to high temperatures.

The coating can be applied to the desired thickness which in most cases is between about ½ inch and about 2 inches. In recent testing, a steel I-beam was coated with a 1 ½ inch thick application of the insulating material of this invention and placed in a 2000° F. furnace. The beam did not reach a failure temperature of 1000° F. until elapse of nearly five hours, compared to slightly over three hours for the best known insulation tested in the past.

Other and further objects of the invention, together with the features of novelty appurtenant thereto, will appear in the course of the following description.

### DESCRIPTION OF THE DRAWING

In the accompanying drawing which forms a part of the specification and is to be read in conjunction therewith:

FIG. 1 is a fragmentary perspective view of a steel I-beam to which reinforcing meshwork and a heat resistant coating have been applied in accordance with a preferred embodiment of the present invention, with portions of the mesh and coating broken away for purposes of illustration.

### DESCRIPTION OF THE PREFERRED EMBODIMENT

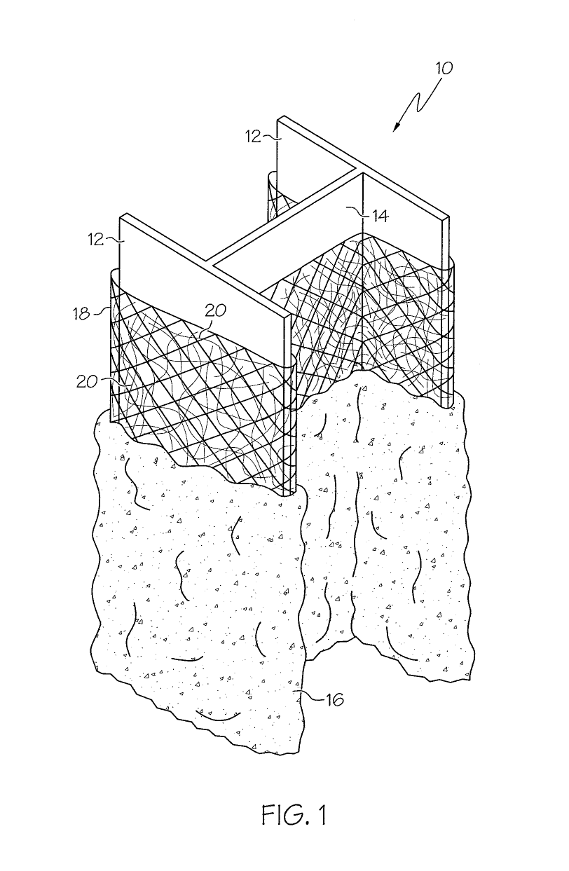

With reference to FIG. 1, numeral 10 generally designates a steel structural member in the form of an I-beam having parallel flanges 12 and a central web 14 connecting the flanges. The beam 10 may function as a structural member in a building or other structure. The beam 10 may be constructed of steel, although other substances are possible.

In accordance with the present invention, a heat resistant coating 16 is applied to the beam 10 or other structural member. The coating 16 is specially formulated to exhibit heat resistant characteristics and is applied to the beam 10 in any suitable manner to surround all parts of the beam and envelope the beam within the coating.

Preferably, before the coating 16 is applied, reinforcement such as a steel mesh 18 is applied to the beam 10. The mesh 18 is preferably an open work mesh such as a mesh of open gauge wire having a plurality of reinforcement strands 20. The mesh 18 is preferably wrapped around or otherwise applied to the entirety of the beam 10, including the inside and outside surfaces and the edges of the flanges 12 and the opposing surfaces of the web 14. The mesh 18 provides reinforcement that minimizes cracking of the coating 16 if the beam 10 should thermally expand when subjected to high temperatures.

As previously indicated, the coating 16 may be applied in any suitable manner.

Preferably, the coating 16 is applied in a semi-liquid form by spraying it onto the meshwork reinforcing strands 20 and the beam 10 by suitable spraying equipment (not shown). The coating is preferably applied to the entirety of the beam surface, including the outside and inside surfaces of the flanges 12 and their edges, and the opposing surfaces of the web 14.

The coating 16 formulated according to the present invention includes cement, gypsum, perlite and a liquid catalyst that includes styrene acrylic. Those constituents may be mixed with water and sprayed or otherwise applied to the beam 10 and the mesh 18.

The cement is preferably Portland cement due to its ready availability. The gypsum may be of the type commercially available and known as hydrostone gypsum. The cement is preferably present in the coating in an amount between about 26% and about 32% by weight. The gypsum is preferably present in the coating in the amount of between about 22% and about 28%.

The perlite included in the formulation may be of two types. One type may be expanded perlite in the form of fine beads. The perlite beads may be present in the coating in an amount between about 5% and about 11% by weight. Expanded perlite beads in the form of No. 6 classified beads may also be included. The No. 6 beads may be present in an amount between about 0.5% and about 3% by weight. Together, the fine beads and the No. 6 beads are thus present in the coating in an amount between about 5.5% and about 14% by weight. The perlite beads are preferably distributed uniformly throughout the coating.

The catalyst may be a catalyst that includes styrene acrylic. Suitable catalysts are commercially available from GeoBond International under the trade designations GeoBond Catalyst H6 or GeoBond Catalyst C. The catalyst may be in a liquid form and is present in the coating in an amount between about 5.7% and about 12% by weight.

The coating may include water present in an amount between about 26% and about 32%. The dry constituents may be blended and mixed thoroughly with the catalyst and water to provide a homogeneous substance that can be sprayed or otherwise applied to the beam 10 and the mesh 18.

The thickness of the coating 16 can vary. Preferably, the coating is between about ½ inch thick and about 2 inches thick as a practical matter. The coating provides significant protection for the beam 10 against exposure to high temperatures that can cause the beam to fail structurally.

In recent testing, a steel I-beam was coated with the coating 16 to a thickness of about 1 ½ inches. The coated beam was put in a 2000° F. furnace, and the temperature of the beam was monitored. Only after the elapse of four hours and 48 minutes in the 2000° F. furnace did the temperature of the beam 10 reach 1000° F. which is considered to be the temperature at which a steel beam fails structurally. The coating 16 thus provided protection against structural failure for nearly five hours. This compares with the best previously known heat insulating material which testing has established as being able to protect the beam under the same conditions for only slightly more than three hours. It is thus evident that the present invention provides a heat resistant structural member that can withstand high temperatures for a much longer period of time before failing than has been achieved in the past. Additionally, the method of the present invention involves providing high temperature protection to a structural member by first applying the reinforcement (the strands 20 of the mesh 18 or other reinforcement) to the beam 10 and then applying the coating 16 to the reinforcing strands 20 and the beam 10 in a manner to assure high temperature protection of the beam.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

1. A construction element comprising:
a structural member; and
a heat resistant coating on said construction member, said coating including cement, gypsum, perlite and a liquid catalyst which includes styrene acrylic.

2. A construction element as set forth in claim 1, wherein said structural member is selected from the group consisting of a steel beam and a steel column.

3. A construction element as set forth in claim 2, including reinforcement strands applied to said structural member, said coating being applied to said reinforcement strands.

4. A construction element as set forth in claim 3, wherein said reinforcement strands comprise a mesh of open gauge wire.

5. A construction element as set forth in claim 1, including reinforcement strands applied to said structural member, said coating being applied to said reinforcement strands.

6. A construction element as set forth in claim 5, wherein said reinforcement strands comprise a mesh of open gauge wire.

7. A construction element as set forth in claim 1, wherein said coating includes water.

8. A construction element as set forth in claim 7, wherein:
said cement is present in said coating in an amount of about 26% to about 32% by weight;
said gypsum is present in said coating in an amount of about 22% to about 28% by weight;
said perlite is present in said coating in an amount of about 5.5% to about 11% by weight;
said catalyst is present in and said coating in an amount of about 5.7% to about 12% by weight.

9. A construction element as set forth in claim 8, wherein said coating has a thickness between about ½ inch and about 2 inches.

10. A construction element as set forth in claim 1, wherein said coating has a thickness between about ½ inch and about 2 inches.

11. A construction element for a building comprising:
a steel structural member comprising a beam or column providing structural support in the building; and
a heat resistant coating applied to and surrounding substantially the entirety of said structural member, said coating comprising cement, gypsum, perlite and a liquid catalyst which includes styrene acrylic.

12. A construction element as set forth in claim 11, including reinforcement strands applied to said structural member, said coating being applied to said reinforcement strands.

13. A construction element as set forth in claim 12, wherein said reinforcement strands comprise a mesh of open gauge wire.

14. A construction element as set forth in claim 11, wherein said coating includes water and wherein:
said cement is present in said coating in an amount of about 26% to about 32% by weight;
said gypsum is present in said coating in an amount of about 22% to about 28% by weight;
said perlite is present in said coating in an amount of about 5.5% to about 11% by weight;
said catalyst is present in and said coating in an amount of about 5.7% to about 12% by weight.

15. A method of insulating a structural member of a building from high temperature, comprising:
applying strands of reinforcement to said structural member; and
applying to said strands of reinforcement and to said structural member a heat resistant coating comprising cement, gypsum, perlite and a liquid catalyst which includes styrene acrylic.

16. A method as set forth in claim 15, wherein said step of applying strands of reinforcement comprises wrapping said structural member in an open gauge wire mesh.

17. A method as set forth in claim 16, wherein said step of applying a heat resistant coating comprises spraying said coating onto said mesh and said structural member.

18. A method as set forth in claim 15, wherein said step of applying a heat resistant coating comprises spraying said coating onto said strands and said structural member.

19. A method as set forth in claim 15, wherein said coating includes water and wherein:
said cement is present in said coating in an amount of about 26% to about 32% by weight;
said gypsum is present in said coating in an amount of about 22% to about 28% by weight;
said perlite is present in said coating in an amount of about 5.5% to about 11% by weight;
said catalyst is present in and said coating in an amount of about 5.7% to about 12% by weight.

20. A method as set forth in claim 15, wherein the step of applying said coating comprises applying said coating to said strands and to said structural member to a thickness between about ½ inch and about 2 inches.
